(19) United States
(12) Patent Application Publication
(10) Pub. No.: US 2013/0314222 A1
(43) Pub. Date: Nov. 28, 2013

(54) ELECTRONIC PARKING BRAKE SYSTEM AND METHOD OF INDICATING MALFUNCTION OF PARKING BRAKE SWITCH

(71) Applicant: MANDO CORPORATION, Pyeongtaek-si (KR)

(72) Inventor: Jae Hyun Park, Seongnam-si (KR)

(73) Assignee: MANDO CORPORATION, Pyeongtaek-si (KR)

(21) Appl. No.: 13/902,209

(22) Filed: May 24, 2013

(30) Foreign Application Priority Data
May 25, 2012 (KR) 10-2012-0055882

(51) Int. Cl. B60Q 1/00

(52) U.S. Cl. CPC B60Q 1/00
USPC 340/453

(57) ABSTRACT

Disclosed herein is a method of indicating malfunction of a parking brake system includes determining whether a parking brake switch including four switches malfunctions, if the parking brake switch malfunctions, determining states of the four switches, monitoring a pattern of a drive signal input to the parking brake switch according to information about the states of the four switches and determining whether the parking brake switch is in an applied state, if the parking brake switch is in the applied state, flickering a lamp to indicate malfunction of the parking brake switch.

CROSS-REFERENCE TO RELATED APPLICATION(S)

This application claims the benefit of Korean Patent Application No. 2012-0055882, filed on May 25, 2012 in the Korean Intellectual Property Office, the disclosure of which is incorporated herein by reference.

### BACKGROUND

1. Field

Embodiments of the present invention relate to an electronic parking brake system which indicates malfunction of a parking brake switch by flickering a lamp only when it is determined that the parking brake system is in an applied state and a method of indicating malfunction of the parking brake switch

2. Description of the Related Art

Generally, a brake system includes a parking brake, which is normally referred to as a hand brake or a side brake to keep a vehicle stationary. The parking brake is actuated as a driver operates a parking lever provided at one side of a driver's seat within a vehicle. When the driver pulls the parking lever, a cable connected to the parking lever is pulled and a rear wheel brake assembly connected to the cable is operated to secure braking force. When the parking lever is released, the cable is released to release the braking force.

However, operating the parking brake using the parking lever as above requires the driver to directly operate the parking lever. Therefore, if the driver attempts to park a vehicle on, e.g., a slope, without pulling the parking lever by mistake, the vehicle may move down the slope, resulting in an accident. Further, since the driver needs to manipulate the parking lever whenever the driver parks the vehicle or starts driving, the use of the parking lever may be troublesome to the driver, particularly to a woman, a weak person or an old person.

For this reason, an Electronic Parking Brake (EPB) to electronically controlled operation of the parking brake has recently been developed. The EPB, is a system which automatically applies or releases the parking brake via a simplified switching operation or determination for control by an electronic control unit even when the driver does not manually operate the parking brake, provides the driver with convenience and stability through various functions such as automatic application of the parking brake in emergency braking and stopping of the engine and anti-slip on a slope.

The EPB as above includes a parking brake switch, an actuator having a motor to generate braking force, and an electronic control unit to drive the actuator. The electronic control unit drives the actuator to apply or release the parking brake system depending on the manipulation state of the parking brake switch.

In addition, if the parking brake switch malfunctions in a manner that the switching state changes regardless of the manipulation state of the parking brake switch, a lamp flickers to indicate malfunction of the parking brake switch.

However, European regulations prescribe that, if the parking brake switch malfunctions, the lamp should flicker only in the applied state of the parking brake switch. Accordingly, to satisfy European regulations, an improved method of displaying a malfunction of the parking brake switch may be needed.

### SUMMARY

Therefore, it is an aspect of the present invention to provide an electronic parking brake system which indicates malfunction of a parking brake switch by flickering a lamp only when it is determined that the parking brake system is in an applied state and a method of indicating malfunction of the parking brake switch.

Additional aspects of the invention will be set forth in part in the description which follows and, in part, will be obvious from the description, or may be learned by practice of the invention.

In accordance with one aspect of the present invention, an electronic parking brake system to indicate a parking brake switch when the parking brake switch malfunctions, includes a parking brake switch comprising four switches and adapted to operate in one of an applied state, a released state and a neutral state according to a pattern of a drive signal input to the four switches, an electronic control unit connected to the parking brake switch via four wires to determine whether the parking brake switch is in the applied state based on states of the four switches input via the four wires, and output an alarm signal if the parking brake switch is in the applied state, and a lamp to flicker according to the alarm signal output from the electronic control unit to indicate that the parking brake switch malfunctions.

The electronic control unit creates the pattern of the drive signal according to the states of the four switches and monitors the created pattern to determine whether the parking brake switch is in the applied state, the released state or the neutral state.

In accordance with another aspect of the present invention, a method of indicating malfunction of a parking brake system includes determining whether a parking brake switch including four switches malfunctions, if the parking brake switch malfunctions, determining states of the four switches, monitoring a pattern of a drive signal input to the parking brake switch according to information about the states of the four switches and determining whether the parking brake switch is in an applied state, if the parking brake switch is in the applied state, flickering a lamp to indicate malfunction of the parking brake switch.

The method according to claim 3, wherein the determining of whether the parking brake switch malfunctions comprises receiving, by an electronic control unit, input signals from a speed sensor to detect the speed of a vehicle, a brake pedal switch to operate a brake, and a master cylinder pressure sensor to detect pressure of a master cylinder which changes according to On/Off of the brake pedal switch, and determining, by the electronic control unit, if the parking brake switch malfunctions by comparing current malfunction information about the parking brake switch corresponding to the input signals with reference malfunction information for the parking brake switch pre-stored in the electronic control unit, based on the input signals input to the electronic control unit.

The electronic control unit is connected to the parking brake switch via four wires, and determines whether the parking brake switch is in the applied state, a released sate, or a neutral state according to the information about the states of the four switches and outputs an alarm signal to the lamp if the parking brake switch is in the applied state.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 is a view illustrating a disc brake to which an electronic parking brake system according to an exemplary embodiment of the present invention is applied;

FIG. 2 is a block diagram of the electronic parking brake system according to the exemplary embodiment of the preset invention;

FIG. 3 is a view illustrating manipulation states of the parking brake switch in the electronic parking brake system according to the exemplary embodiment of the preset invention;

FIG. 4 is a table showing drive signal patterns of the first to fourth switches according to manipulation states of the parking brake switch in the parking brake system according to the exemplary embodiment of the present invention; and

FIG. 5 is a flowchart illustrating a method of indicating malfunction of the parking brake switch in the electronic parking brake system according to the exemplary embodiment of the present invention.

### DETAILED DESCRIPTION

Reference will now be made in detail to the embodiments of the present invention, examples of which are illustrated in the accompanying drawings, wherein like reference numerals refer to like elements throughout.

Electronic parking brake systems are classified into a cable puller type, a motor-on-caliper type and a hydraulic parking brake type according to operation types. An electronic parking brake system automatically operates to keep a vehicle parked or stationary when the vehicle is stopped or there is a risk of a vehicle moving backward when started on a slope.

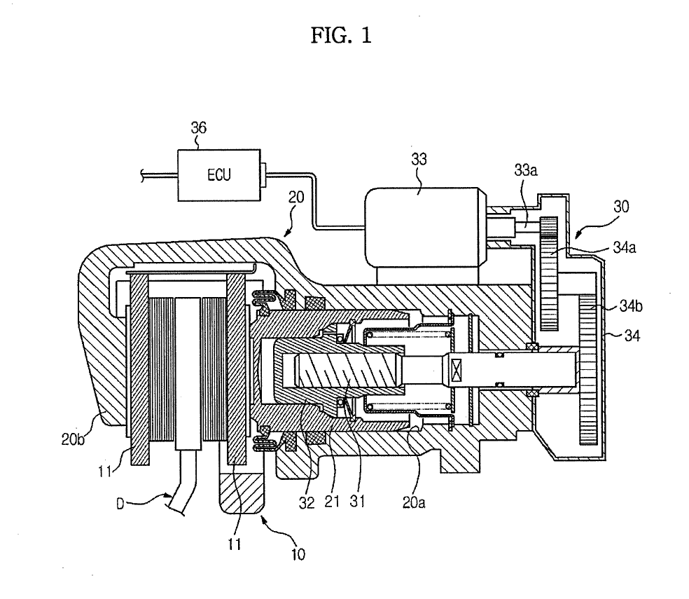

FIG. 1 is a view illustrating a disc brake to which an electronic parking brake system according to an exemplary embodiment of the present invention is applied. The electronic brake system described as an example in the illustrated embodiment is of the motor-on-caliper type.

In FIG. 1, the disc brake having the function of the electronic parking brake system includes a carrier 10 coupled to a vehicle body and having a pair of friction pads 11 installed therein spaced a predetermined distance apart from each other, and a caliper housing 20 installed at the carrier 10 to be movable back and forth, provided with a cylinder portion 20a having a piston 21 installed therein to be movable back and forth to press the two friction pads 11 against a disc D and provided, at one side opposite the cylinder portion 20a, with a finger portion 20b.

The disc brake further includes an electronic parking brake system 30 to function as a parking brake. The electronic parking brake system 30 includes an actuating shaft 31 rotatably installed in the cylinder portion 20a of the caliper housing 20, a pressure sleeve 32 installed inside the piston 21 to be moved back and forth by rotation of the actuating shaft 31 so as to apply or release pressure on the piston 21, a motor 33 to rotate the actuating shaft 31, a reduction gear assembly 34 including a plurality of gears 34a and 34b to transmit power generated from a rotating shaft 33a of the motor 33 to the actuating shaft 31 at a reduced rate of rotation, and an electronic control unit (ECU) 36 to manage overall control operations.

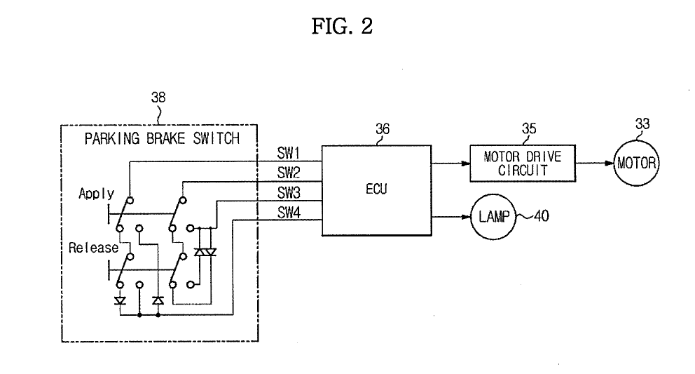

FIG. 2 illustrates a block diagram of the electronic parking brake system according to the exemplary embodiment of the preset invention.

In FIG. 2, the electronic parking brake system 30 includes the ECU 36, a motor drive circuit 35 to apply electrical current to the motor 33 to apply or release parking brake force according to a parking brake signal or parking brake release signal of the ECU 36, a parking brake switch 38 manipulated by a driver to generate the parking brake signal or parking brake release signal of the ECU 36, and a lamp 40 to indicate malfunction of the parking brake switch 38.

The parking brake switch 38 is a 4-wire type electronic parking brake switch having four switches from a first switch SW1 to a fourth switch SW4. Each of the switches SW1 to SW4 is connected with a wire. The four wires connect the parking brake switch 38 with the ECU 36.

The ECU 36 is provided with a micro controller unit (MCU). A pattern of an drive signals output from the MCU is created by diodes which are configured according to manipulation states of the switches SW1 to SW 4, and the MCU monitors the created pattern and determines whether the parking brake switch 38 is in the applied state (Apply), release state (Release) or neutral state (Neutral).

The parking brake switch 38, which is a device that is first manipulated to move a vehicle, needs to operate distinguishably in each of the manipulation states

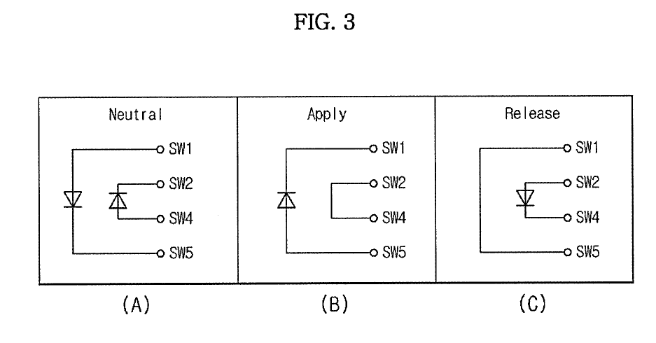

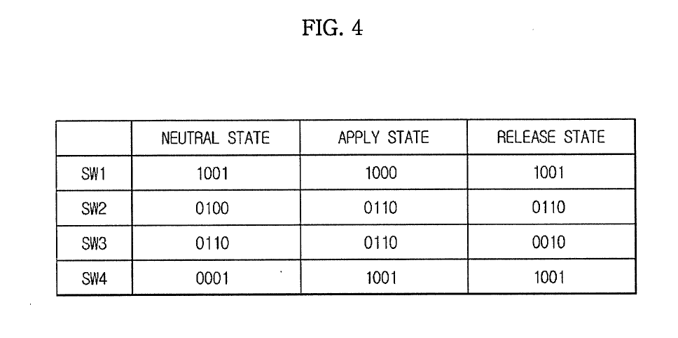

(Apply, Release, and Neutral) since poor initial movement may lead to failure of movement of the vehicle itself. The manipulation states will be described with reference to FIGS. 3 and 4.

FIG. 3 is a view illustrating manipulation states of the parking brake switch in the electronic parking brake system according to the exemplary embodiment of the preset invention.

FIG. 3(A) shows the drive enable state of the switches SW1 to SW4 in the Neutral state of the parking brake switch 38, FIG. 3(B) shows the drive enable state of the switches SW1 to SW4 in the Apply state of the parking brake switch 38, and FIG. 3(C) shows the drive enable state of the switches SW1 to SW4 in the Release state of the parking brake switch 38.

FIG. 4 is a table showing drive signal patterns of the first to fourth switches according to manipulation states of the parking brake switch in the parking brake system according to the exemplary embodiment of the present invention.

When the parking brake switch 38 is in the Neutral state, a signal pattern is created to assign “1001” to the first switch SW1, “0100” to the second switch SW2, “0110” to the third switch SW3, and “0001” to the fourth switch SW4.

When the parking brake switch 38 is in the Apply state, a signal pattern is created to assign “1000” to the first switch SW1, “0110” to the second switch SW2, “0110” to the third switch SW3, and “1001” to the fourth switch SW4.

When the parking brake switch 38 is in the Release state, a signal pattern is created to assign “1001” to the first switch SW1, “0110” to the second switch SW2, “0010” to the third switch SW3, and “1001” to the fourth switch SW4.

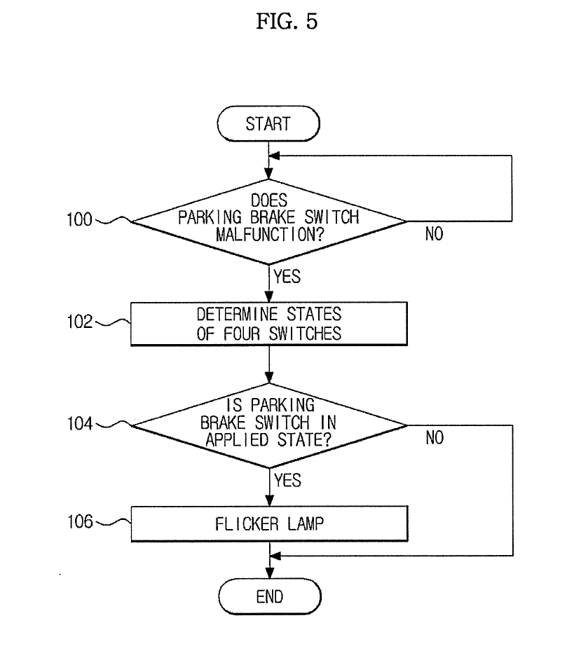

Accordingly, the ECU 36 determines whether the parking brake switch 38 is in the Apply state, Release state or Neutral state based on the drive signal patterns of the first to fourth switches SW1 to SW4 and indicates malfunction of the parking brake switch 38 when the malfunction occurs in a method that satisfies European regulations. The method will be described with reference to FIG. 5.

FIG. 5 is a flowchart illustrating a method of indicating malfunction of the parking brake switch in the electronic parking brake system according to the exemplary embodiment of the present invention.

The ECU 36 determines whether the parking brake switch 38 malfunctions (100), and if the parking brake switch 38 does not malfunction, it turns back to operation 100 and proceeds with subsequent operations.

The ECU 36 determines whether or not the parking brake switch 38 malfunctions by receiving input signals from a speed sensor to detect the speed of the vehicle, a brake pedal switch to operate the brake, and a master cylinder pressure sensor to detect pressure of the master cylinder which changes according to On/Off of the brake pedal switch and determining, based on the input signals, if pre-stored conditions of malfunction of the parking brake switch 38 are met to determine if the parking brake switch 38 malfunctions.

If the result of determination in operation 100 is that parking brake switch 38 malfunctions, the ECU 36 determines states of the first to fourth switches SW1 to SW4 provided in the four wires connecting the parking brake switch 38 and the ECU 36 (102).

The states of the switches SW1 to SW4 are determined using the drive signal pattern of the first switch SW1 and the fourth switch SW4 and the drive signal pattern of the second switch SW2 and the third switch SW3.

Depending on the result of determination of the states of the switches SW1 to SW4 in operation 102, the ECU 36 determines whether the parking brake switch 38 is in the Apply state (104).

If the result of determination in operation 104 is that the parking brake switch 38 is in the Apply state, the ECU 36 outputs an alarm signal to the lamp 40 to indicate malfunction of the parking brake switch 38.

Thereby, the lamp 40 flickers according to the alarm signal output from the ECU 36 to inform the driver of malfunction of the parking brake switch 38 (106).

As is apparent from the above description, when a parking brake switch of an electronic parking brake system malfunctions, the manipulation state of the parking brake switch is determined and malfunction is indicated by flickering a lamp only when the parking brake switch is in an applied state. Thereby, convenience and stability may be provided for a driver, and the electronic parking brake system may satisfy the European regulations.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An electronic parking brake system to indicate a parking brake switch when the parking brake switch malfunctions, the electronic parking brake system comprising:
a parking brake switch comprising four switches and adapted to operate in one of an applied state, a released state and a neutral state according to a pattern of a drive signal input to the four switches;
an electronic control unit connected to the parking brake switch via four wires to determine whether the parking brake switch is in the applied state based on states of the four switches input via the four wires, and output an alarm signal if the parking brake switch is in the applied state; and
a lamp to flicker according to the alarm signal output from the electronic control unit to indicate that the parking brake switch malfunctions.

2. The electronic parking brake system according to claim 1, wherein the electronic control unit creates the pattern of the drive signal according to the states of the four switches and monitors the created pattern to determine whether the parking brake switch is in the applied state, the released state or the neutral state.

3. A method of indicating malfunction of a parking brake system, comprising:
determining whether a parking brake switch including four switches malfunctions;
if the parking brake switch malfunctions, determining states of the four switches;
monitoring a pattern of a drive signal input to the parking brake switch according to information about the states of the four switches and determining whether the parking brake switch is in an applied state;
if the parking brake switch is in the applied state, flickering a lamp to indicate malfunction of the parking brake switch.

4. The method according to claim 3, wherein the determining of whether the parking brake switch malfunctions comprises receiving, by an electronic control unit, input signals from a speed sensor to detect the speed of a vehicle, a brake pedal switch to operate a brake, and a master cylinder pressure sensor to detect pressure of a master cylinder which changes according to On/Off of the brake pedal switch, and determining, by the electronic control unit, if the parking brake switch malfunctions by comparing current malfunction information about the parking brake switch corresponding to the input signals with reference malfunction information for the parking brake switch pre-stored in the electronic control unit, based on the input signals input to the electronic control unit.

5. The method according to claim 4, wherein the electronic control unit is connected to the parking brake switch via four wires, and determines whether the parking brake switch is in the applied state, a released sate, or a neutral state according to the information about the states of the four switches and outputs an alarm signal to the lamp if the parking brake switch is in the applied state.
